(19) United States
(12) Patent Application Publication
(10) Pub. No.: US 2013/0162222 A1
(43) Pub. Date: Jun. 27, 2013

(54) CHARGING CONTROL CIRCUIT

(71) Applicants: JUI-LIN KE, Tu-Cheng (TW); LEI WANG, Shenzhen City (CN); HUAI-LONG WANG, Shenzhen City (CN); YANG LIU, Shenzhen City (CN)

(72) Inventors: JUI-LIN KE, Tu-Cheng (TW); LEI WANG, Shenzhen City (CN); HUAI-LONG WANG, Shenzhen City (CN); YANG LIU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/426,631

(22) Filed: Mar. 22, 2012

(30) Foreign Application Priority Data
Dec. 24, 2011 (CN) 201110438362.5

(51) Int. Cl. H02J 7/00

(52) U.S. Cl. 320/162

(57) ABSTRACT

A charging control circuit includes a switch circuit, a charging circuit, a central processing unit (CPU), and an identification circuit including two monitoring points for being connected to a first or second electronic device, and a mechanical switch connected between the two monitoring points. When charging the first electronic device, the mechanical switch switches to a first state where a voltage drop is generated on the two monitoring points respectively, and the switch circuit is turned on. When charging the second electronic device, the mechanical switch switches to a second state where the connection between the two monitoring points is short circuit, and the switch circuit is turned off. The CPU enables the charging circuit when the switch circuit is turned on or off to provide power to the first or the second electronic device via the charging unit.

### BACKGROUND

1. Technical Field

The present disclosure relates to charging circuits, and particularly, to a charging control circuit capable of charging electronic devices with different charging interfaces.

2. Description of the Related Art

Different electronic devices require charging interfaces to be matched to chargers. For example, a first charger for charging a first electronic device provides four chip resistors embedded in a USB interface. When the first charger is connected to a power supply to charge the first electronic device, a first detecting pin D− and a second detecting D+ of the USB interface detect voltage drop respectively generated by the four chip resistors. The first electronic device enables a charging circuit when the voltage drop is determined to match a predetermined voltage. However, a second electronic device enables a charging circuit when the connection between the first detecting pin D− and the second detecting pin D+ is determined to be short circuit. Thus, the first charger cannot be used to charge the second electronic device, namely the first electronic device and the second electronic device cannot be charged by a same charger, which may be inconvenient for the users.

Therefore, there is room for improvement within the art.

### BRIEF DESCRIPTION OF THE DRAWINGS

The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of a charging control circuit in accordance with an exemplary embodiment.

FIG. 2 is a circuit diagram of the charging control circuit of FIG. 1 in accordance with an exemplary embodiment.

FIG. 3 is a circuit diagram of the charging control circuit of FIG. 1 in accordance with another exemplary embodiment.

### DETAILED DESCRIPTION

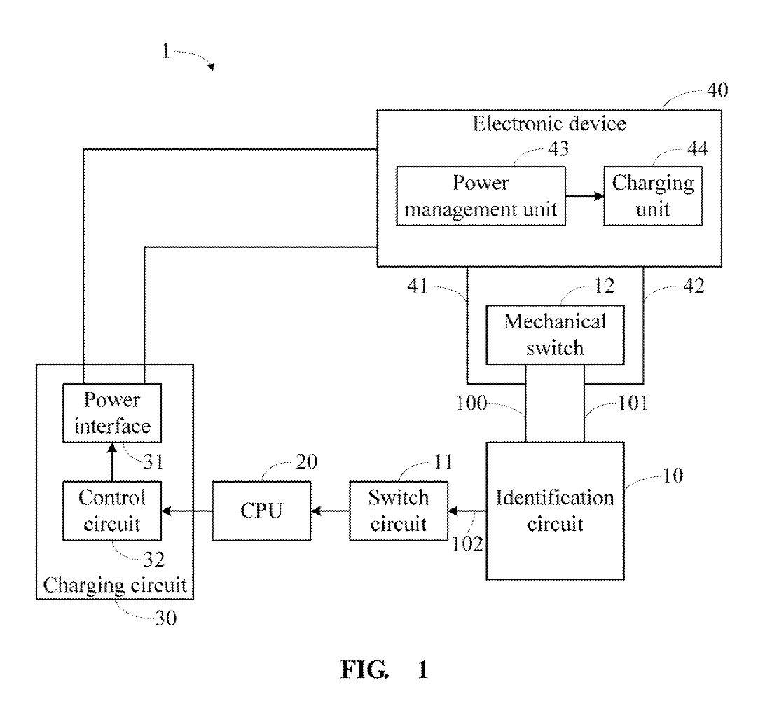

FIG. 1, is a charging control circuit 1 in accordance with an exemplary embodiment. A charger (not shown) with the charging control circuit 1 can be used to charge a first electronic device via a first charging interface of the first electronic device and a second electronic device via a second charging interface of the second electronic device, the first charging interface is different from the second charging interface. The charging control circuit 1 includes an identification circuit 10, a switch circuit 11, a mechanical switch 12, a central processing unit (CPU) 20, and a charging circuit 30. In the embodiment, the identification circuit 10 includes a first monitoring point 100 and a second monitoring point 101. When the first electronic device/the second electronic device 40 is connected to the charging control circuit 1, the first monitoring point 100 is connected to a first detecting pin 41 of the electronic device 40 and the second monitoring point 101 is connected to a second detecting pin 42 of the electronic device 40.

The electronic device 40 includes a power management unit 43 and a charging unit 44. When the charger with the charging control circuit 1 is connected to a power supply 50, a voltage drop is generated between the first monitoring point 100 and the second monitoring point 101. The management unit 43 enables the charging unit 44 when the generated voltage drop is determined to match a predetermined voltage.

The switch circuit 11 is configured to be turned on or turned off according to whether the voltage drop is generated between the first monitoring point 100 and the second monitoring point 101. If the voltage drop is generated between the first monitoring point 100 and the second monitoring point 101, the switch circuit 11 is turned on, if no voltage drop is generated, the switch circuit 11 is turned off. The CPU 20 enables the charging circuit 30 to charge different electronic devices 40 according to the on or off state of the switch circuit 11.

The switch circuit 11 is connected to an output port 102 of the identification circuit 10. In the embodiment, the switch circuit 11 includes semiconductor elements. The mechanical switch 12 is received in the charger and a portion of the mechanical switch 12 is external to the charger for users to operate. The mechanical switch 12 is connected between the first monitoring point 100 and the second monitoring point 101.

The charging circuit 30 includes a charging interface 31 and a control circuit 32. The electronic device 40 is connected to the charger via the charging interface 31. The control circuit 32 enables the charging interface 31 according to the on or off state of the switch circuit 11, and the power supply 50 charges the electronic device 40 via the enabled charging interface 31.

When the first electronic device is connected to the charging control circuit 1, the first monitoring point 100 is connected to the first detecting pin 41 and the second monitoring point 101 is connected to the second detecting pin 42. The mechanical switch 12 is operated to be in a first state to generate the voltage drop on the first monitoring point 100 and second monitoring point 101, thereby the switch circuit 11 is turned on, and the CPU 20 enables the charging circuit 30. The power management unit 43 determines whether the voltage drop generated between the first monitoring point 100 and the second monitoring point 101 matches a predetermined voltage. When the generated voltage drop is determined to match the predetermined voltage, the power management unit 43 enables the charging unit 44. The CPU 20 first turns off the control circuit 32, and then turns on the control circuit 32 when the switch circuit 11 is turned on, thereby the power supply 50 charges the electronic device 40 via the charging unit 44.

When the second electronic device is connected to the charging control circuit 1, the first monitoring point 100 is connected to the first detecting pin 41 and the second monitoring point 101 is connected to the second detecting pin 42. The mechanical switch 12 is operated to be in a second state to short the connection between the first monitoring point 100 and second monitoring point 101, thereby the switch circuit 11 is turned off, and the CPU 20 enables the charging circuit 30. If the power management unit 43 determines the short between the first monitoring point 100 and the second monitoring point 101, the power management unit 43 enables the charging unit 44. The CPU 20 first turns off the control circuit 32, and then turns on the control circuit 32 when the switch circuit 11 is turned off, thereby the power supply 50 charges the electronic device 40 via the charging unit 44.

In the embodiment, the first level signal is a high level signal, and the second level signal is a low level signal.

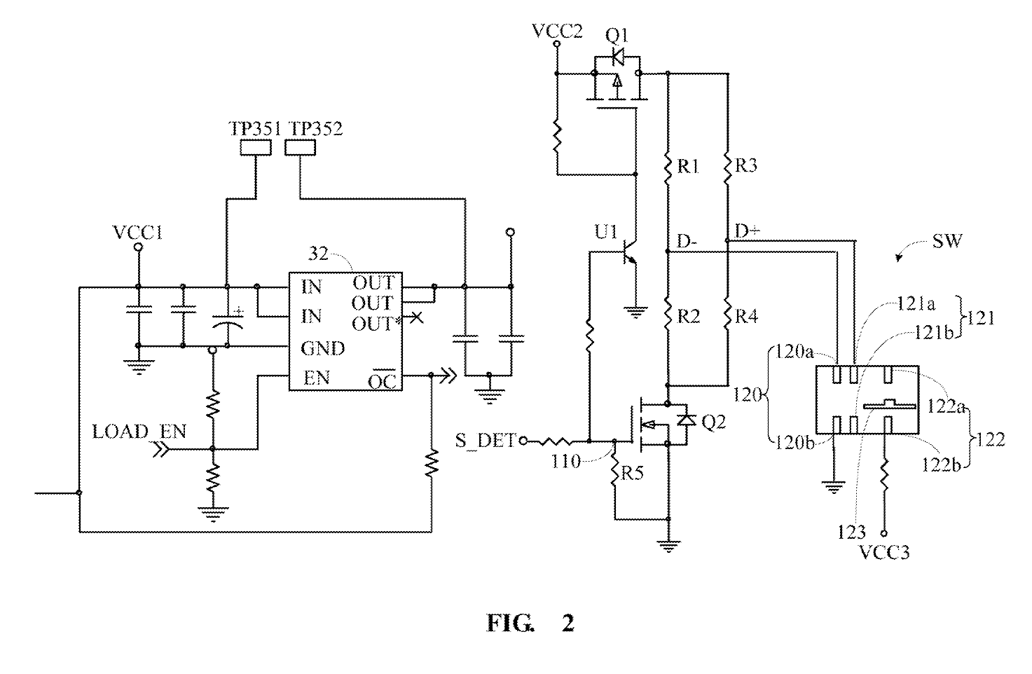

FIG. 2, is a circuit diagram of the charging control circuit 1. TP351 and TP352 are the charging interfaces 31 for connecting the electronic device 40. VCC1 is an output of the power supply 50 (not shown). The CPU 20 includes a LOAD_EN port for outputting a level signal, and a S_DET port for inputting a control signal.

The switch circuit 11 includes a field-effect transistor Q1, a field-effect transistor Q2, and resistors R1-R4. The series resistors R1 and R2 are connected to the series resistors R3 and R4 in parallel. The grid of the field-effect transistor Q1 is connected to a collector of a triode U1, the drain is connected to a first end of the resistor R1 and further to a first end of the resistor R2, and the source is connected to a power input port VCC2. The grid of the field-effect transistor Q2 is connected to the resistor R2 and further to the resistor R4, the source is ground, and the drain is connected to the source via a resistor R5 to form a junction 110 which is connected to the S_DET port.

SW is the mechanical switch 12. In the embodiment, the mechanical switch 12 includes a first sub switch 120, a second sub switch 121, a third sub switch 122, and a dynamic terminal 123. A first static terminal 120a of the first sub switch 120 is connected between the resistor R1 and the resistor R2 to form a first detecting point D−, namely the first monitoring point 100, which is connected to the detecting pin 41 of the electronic device 40. A first static terminal 121 a of the second sub switch 121 is connected between the resistor R3 and resistor R4 to form a second detecting point D+, namely the second monitoring point 101, which is connected to the detecting pin 42 of the electronic device 40. A second static terminal 120b is grounded. A second static terminal 121b is connected to the S_DET port. A second static terminal 122b is connected to a power supply port VCC3 via a resistor R6.

To charge the first electronic device when the first electronic device is connected to the charging control circuit 1, the first detecting point D− is connected to the detecting pin 41, and the second detecting point D+ is connected to the detecting pin 42. The dynamic terminal 123 is moved to connect the first static terminal 121a to the first static terminal 122a and further connect the second static terminal 121b to the second static terminal 122b. When the second static terminal 121b is connected to the second static terminal 122b, the S_DET port detects a high level signal to turn on the field-effect transistor Q2. After the field-effect transistor Q2 is turned on, a voltage drop is generated between the source and the grid of the field-effect transistor Q1, and the field-effect transistor Q1 is correspondingly turned on. The first detecting point D− and the second detecting point D+ generate a first voltage and a second voltage respectively, thereby connecting the resistors R1-R4 to the charging unit 44 of the first electronic device. The power management unit 43 determines whether the first voltage and the second voltage match predetermined voltages, and further enables the charging unit 44 when the first voltage and the second voltage match the predetermined voltages. The CPU 20 sends a control signal to the control circuit 32 via the LOAD_EN port by detecting the high level signal generated by the S_DET port. The control circuit 32 first resets and then restarts to provide the power provided by the power supply 50 to the first electronic device via the power supply port VCC1. In the embodiment, the control circuit 32 is an integrated circuit (IC) connected to the power supply port VCC1 and the charging interfaces TP351 and TP352.

To charge the second electronic device when the second electronic device is connected to the charging control circuit 1, the first detecting point D− is connected to the detecting pin 41 and the second detecting point D+ is connected to the detecting pin 42. The dynamic terminal 123 is moved to connect the first static terminal 120a to the first static terminal 121a. When the first static terminal 120a is connected to the first static terminal 121a, the connection between the first detecting point D− and the second detecting point D+ is shorted, and the S_DET port detects a low level signal to turn off the field-effect transistor Q1. After the field-effect transistor Q1 is turned off, a voltage of the grid of the field-effect transistor Q2 is pulled down, and the field-effect transistor Q2 is correspondingly turned off. The resistors R1-R4 are not connected to the charging unit 44 of the second electronic device. The power management unit 43 enables the charging unit 44 when the connection between the first detecting point D− and the second detecting point D+ is determined to be shorted. The CPU 20 sends a control signal to the control circuit 32 via the LOAD_EN port by detecting the low level signal generated by the S_DET port. The control circuit 32 first resets and then restarts to provide the power provided by the power supply 50 to the second electronic device via the power supply port VCC1.

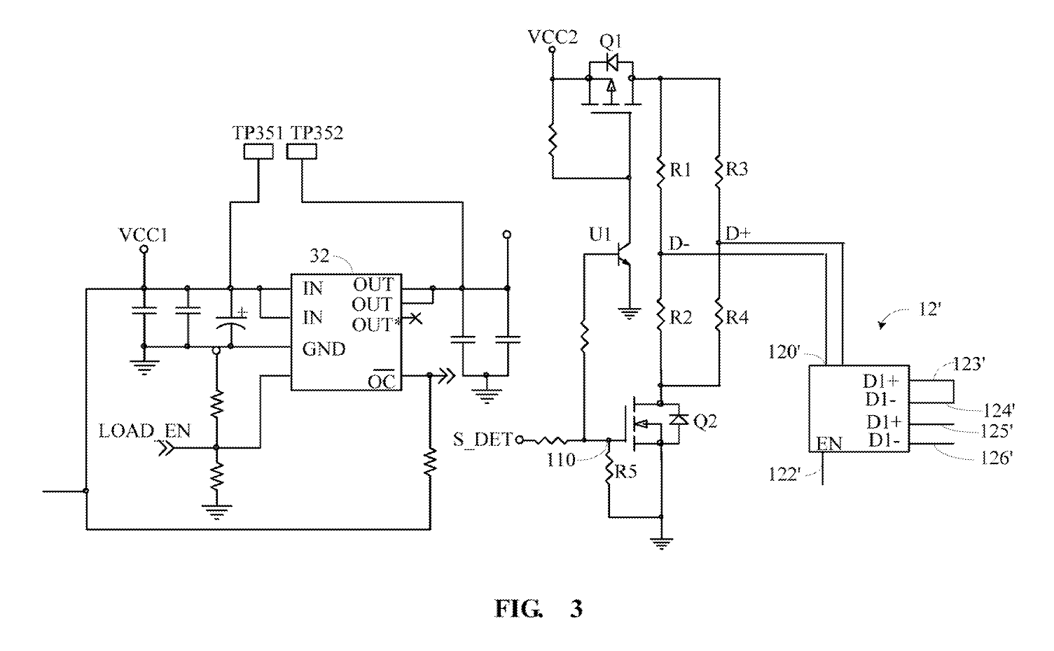

FIG. 3, in the embodiment, shows the mechanical switch 12 is a USB switch 12′. The US switch 12′ includes a first input terminal 120′, a second input terminal 121′, an EN terminal 122′, a first output terminal 123′, a second output terminal 124′, a third output terminal 125′ and a fourth output terminal 126′. The first input terminal 120′ is connected to the first detecting point D− and the second input terminal 121′ is connected to the second detecting point D+. The first output terminal 123′ is connected to the second output terminal 124′. The EN terminal 122′ is connected to the CPU 20.

To charge the first electronic device when the first electronic device is connected to the charging control circuit 1, the first output terminal 123′, the second output terminal 124′, the third output terminal 125′, and the fourth output terminal 126′ are connected to four detecting pins (not shown) of the electronic device respectively. The CPU 20 controls the first input terminal 120′ to be connected to the second input terminal 121′, and the third output terminal 125′ to be connected to the fourth output terminal 126′, in response to a trigger signal generated by a selection of a user received via the EN port 122′. Then the charging control circuit 1 can charge the first electronic device as above description.

To charge the second electronic device when the second electronic device is connected to the charging control circuit 1, the first output terminal 123′, the second output terminal 124′, the third output terminal 125′, and the fourth output terminal 126′ are connected to the four detecting pins of the electronic device respectively. The CPU 20 controls the first input terminal 120′ to be connected to the second input terminal 121′, and the first output terminal 123′ to be connected to the second output terminal 124′ in response to a trigger signal generated by a selection of a user received via the EN port 122′. Then the charging control circuit 1 can charge the second electronic device as above description.

It is understood that the present disclosure may be embodied in other forms without departing from the spirit thereof. Thus, the present examples and embodiments are to be considered in all respects as illustrative and not restrictive, and the disclosure is not to be limited to the details given herein.

What is claimed is:

1. A charging control circuit capable of charging a first electronic device and a second electronic device, wherein each of the first electronic device and the second electronic device includes a first detecting pin, a second detecting pin, and a charging unit, the charging control circuit comprising:
a charging interface configured for electrical connection to the first electronic device or the second electronic device to the charging control circuit;
an identification circuit comprising a first monitoring point and a second monitoring point for being connected to the first detecting pin and the second detecting pin of the first electronic device or the second electronic device respectively when the first electronic device or the second electronic device is connected to the charging control circuit;
a mechanical switch connected between the first monitoring point and the second monitoring point, configured for selectively switching between a first state where a first voltage drop and a second voltage drop are generated on the first monitoring point and second monitoring point respectively, and a second state where the connection between the first monitoring point and second monitoring point is shorted; thereby the first electronic device connected to the charging control circuit enables the charging unit when the first voltage drop and the second drop voltage are determined to match predetermined voltage values, and the second electronic device enables the charging unit when the connection between the first monitoring point and second monitoring point is shorted;
a switch circuit configured for being turned on according to the first voltage drop and the second drop voltage generated on the first monitoring point and second monitoring point and being turned off when the connection between the first monitoring point and second monitoring point is shorted;
a charging circuit configured for providing power provided by a power supply to the charging unit of the first electronic device or the second electronic device which is connected to the charging control circuit via the charging interface; and
a central processing unit (CPU) configured for enabling the charging circuit when the switch circuit is turned on or off.

2. The charging control circuit as recited in claim 1, wherein the first level signal is a high level signal, and the second level signal is a low level signal.

3. The charging control circuit as recited in claim 1, wherein the CPU first disables the control circuit, then enables the control circuit when the switch circuit is turned on or off to charge the first electronic device or the second electronic device via the charging unit.

4. The charging control circuit as recited in claim 3, wherein the identification circuit comprises a first resistor, a second resistor connected to the first resistor in series, a third resistor, and a fourth resistor connected to the third resistor in series, the first and second series resistors are connected to the third and fourth series resistors in parallel;
the switch circuit comprises a first switch element and a second switch element, a first terminal of the first switch element is connected to the first and third resistors, a second terminal of the first switch element is connected to a first terminal of the second switch element to form an output port, a second terminal of the second switch is connected to the second and fourth resistors, and a third terminal of the second switch is grounded; and
the CPU is configured to control the second switch element to be selectively on or off to allow the first switch to be on or off accordingly.

5. The charging control circuit as recited in claim 4, wherein the first switch element and the second element are field-effect transistors.

6. The charging control circuit as recited in claim 4, wherein the mechanical switch comprises a first sub switch, a second sub switch, a third sub switch, and a dynamic terminal, a first static terminal of the first sub switch is connected between the first resistor and the second resistor to form the first monitoring point, a first static terminal of the second sub switch is connected between the third resistor and the fourth resistor to form the second monitoring point, a second static terminal of the first sub switch is grounded, a second static terminal of the second sub switch is connected to the CPU, a second static terminal of the third sub switch is connected to the output port; the manual operation acted upon the mechanical switch allowing the CPU to control the second switch to be on or off accordingly.

7. The charging control circuit as recited in claim 4, wherein the mechanical switch comprises a first input terminal, a second input terminal, a third input terminal, a first output terminal, a second output terminal, a third output terminal and a fourth output terminal, the first input terminal is connected to the first monitoring point, the second input terminal is connected to the second monitoring point, the first output terminal is connected to the second output terminal, and the third input terminal is connected to the CPU; the manual operation acted upon the mechanical switch allowing the CPU to control the second switch to be on or off accordingly.
